(19) United States
(12) Patent Application Publication
(10) Pub. No.: US 2008/0083674 A1
(43) Pub. Date: Apr. 10, 2008

(54) Apparatus for and Method of Dosing a Wastewater Treatment System

(76) Inventors: Murphy J. Cormier, Lake Charles, LA (US); Troy L. Cormier, Lake Charles, LA (US); Ronald J. Suchecki, China Spring, TX (US); Robert K. Pertuit, Sulphur, LA (US); Donald L. Brown, Flint, TX (US)

Correspondence Address: EMERGING STRATEGIES, PLLC, 5440 31ST STREET, N.W., WASHINGTON, DC, 20015-1346, US

(21) Appl. No.: 11/539,174

(22) Filed: Oct. 6, 2006

(51) Int. Cl. C02F 1/00

(52) U.S. Cl. 210/744; 210/764; 210/209

(57) ABSTRACT

A reservoir is configured to receive a first fluid, and has an inlet configured to receive a second fluid and an outlet. Second fluid received in the reservoir drives a corresponding amount of first fluid out of the outlet and into the wastewater treatment system. A method also is disclosed.

### BACKGROUND OF THE INVENTION

Wastewater treatment plants typically include a pump tank that stores treated effluent until some triggering event occurs, and then the treated effluent is pumped to ground. The treated effluent from a pump tank may be connected to a sprinkler system and used to water a garden or lawn proximate to the wastewater treatment plant.

Unfortunately, the aerobic and anaerobic processes involved in breaking down the effluent do not reduce pathogens that, if discharged, could cause great harm to the nearby living organisms. Accordingly, most wastewater treatment plants provide for disinfecting the treated effluent prior to discharge.

Water and wastewater treatment processes typically conclude by disinfecting with a disinfectant or biocidal agent, such as bromine or chlorine. Chlorine is the most common water and wastewater agent used throughout the world today.

A variety of techniques are known or used for introducing these and other agents into an aqueous solution. Some treatment techniques involve manually adding a liquid or granular agent to the effluent. A drawback to this method is exposing the person handling the agent to potentially hazardous chemicals. Another drawback is the deterioration of the activeness of the agent when exposed to ambient conditions, such as humidity.

Small wastewater plants, such as residential and some commercial wastewater treatment plants, use chlorine tablets composed of mainly calcium hypochlorite. See, for example, U.S. Pat. No. 6,281,802. However, tablets are problematic because they tend to absorb moisture and disintegrate, especially in wastewater treatment plants, thus do not store well or readily advance for use. Tablet dispensers also require dedicated equipment to effect dispensing.

Some techniques employ an agent distributor, such as a dissolve- or erosion-type flow-through feeder. Dissolve/erosion-type feeders typically introduce low-solubility agents into aqueous systems. Generally, dissolve/erosion feeders operate by establishing a flow of solution through the feeder to cause surface friction between the solution and the agent granules or tablets, thereby eroding the surfaces thereof and dissolving the displaced particles. See, for example, U.S. Pat. No. 5,405,540, issued Apr. 11, 1995, to N. Tang. However, a significant drawback of dissolve/erosion-type feeders is, because granule/tablet dissolution rate is dependent on solution temperature and flow rate, inter alia, the difficulty in predicting agent quantity requirements. Dissolve/erosion-type feeders also require dedicated equipment to effect dispensing.

Small and larger wastewater plants may pump a liquid disinfectant into the effluent with a dedicated pump. This adds cost and another component with potential for failure in a waste water treatment plant.

Small and larger wastewater plants also may draw liquid disinfectant into the wastewater via, for example, a venturi. See, for example, U.S. Pat. No. 6,932,912. Venturis are problematic because they are not susceptible to in situ fine-tuning, that is, are not adjustable during operation to draw varying amounts of a fluid into a main fluid stream, thus cannot aid in optimizing the amount disinfectant added based on sensed parameters of the wastewater in the tank.

Larger wastewater plants may inject or bubble gaseous disinfectant through the wastewater with a dedicated injector. See, for example, U.S. Pat. No. 3,853,764. As with pumping liquid disinfectant, gas injection adds cost and another component with potential for failure in a waste water treatment plant.

Unfortunately, none of the foregoing provides an apparatus for and method of dosing a wastewater treatment system, particularly suited for disinfection, that is readily attenuable and does not require dedicated equipment to drive the dosing.

What are needed and not taught or suggested in the art are an apparatus for and method of dosing a wastewater treatment system, particularly suited for disinfection, that a wastewater treatment system fluid source or pump, such as an air compressor, drives according to a sensed need.

### SUMMARY OF THE INVENTION

The invention overcomes the disadvantages noted above by providing an apparatus for and method of dosing a wastewater treatment system, particularly suited for disinfection, that a wastewater treatment system air compressor drives according to a sensed need.

To that end, an embodiment of an apparatus for dosing a wastewater treatment system includes a reservoir configured to receive a first fluid, and having an inlet configured to receive a second fluid and an outlet. Second fluid received in the reservoir drives a corresponding amount of first fluid out of the outlet and into the wastewater treatment system.

An embodiment of a method of dosing a wastewater treatment system configured according to principles of the invention includes providing a reservoir for receiving a first fluid and a second fluid, and causing a ratio of an amount of the first fluid relative to an amount of the second fluid to decrease, wherein the wastewater treatment system receives a corresponding amount of the first fluid.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a vertical cross-sectional detail view of an embodiment of an apparatus for dosing a wastewater treatment system configured according to principles of the invention;

FIGS. 2 and 3 are schematic representations of alternative configurations of a portion of the embodiment of FIG. 1; and

FIG. 4 is schematic view of an embodiment of a method of dosing a wastewater treatment system configured according to principles of the invention.

### DETAILED DESCRIPTION OF THE PREFERRED EMBODIMENTS

The invention is an apparatus for and method of dosing a wastewater treatment system, particularly suited for disinfection, that a wastewater treatment system fluid source or pump, such as an air compressor, drives according to a sensed need.

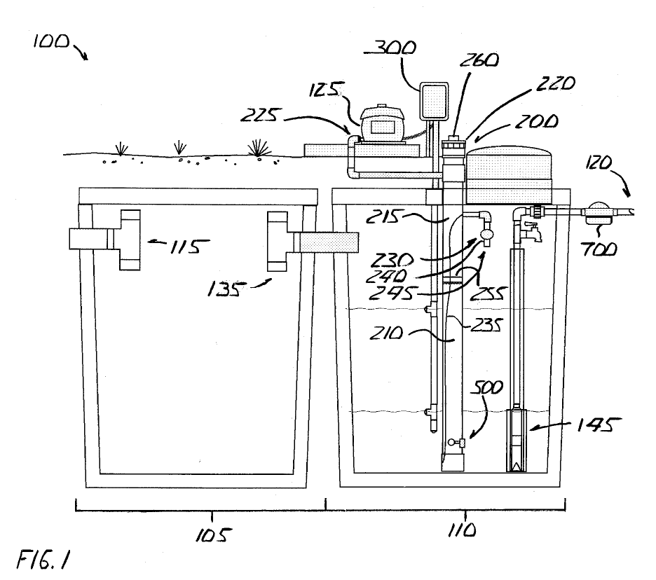

Referring to FIG. 1, a conventional wastewater treatment system 100 includes at least a first chamber 105 for receiving and treating raw effluent and a second chamber 110 for receiving treated effluent for subsequent return to the environment. Raw effluent enters first chamber 105 via an inlet 115, and exits second chamber 110 via outlet 120.

Wastewater treatment system 100 includes a fluid source 125 for delivering a fluid, such as air, for example, for aerobic decomposition of wastewater therein. For example, fluid source 125 may supply diffusers (not shown) that bubble small air bubbles up from the bottom of first chamber 105.

Effluent entering chamber 105 hydrodynamically urges or displaces effluent already in chamber 105 into chamber 110 via, for example a passage 135 or any mechanism for transferring fluid from chamber 105 to chamber 110.

A pump 145 in chamber 110 pumps effluent from chamber 110 to ground.

An embodiment of an apparatus for dosing a wastewater treatment system 200 configured according to principles of the invention includes a reservoir 205 configured for receiving a first fluid 210 and a second fluid 215. A cap 220 provides access to reservoir 205 for introducing first fluid 210 therein. An inlet valve 225 regulates flow of second fluid 215, such as air, from air compressor 120, into reservoir 205.

Ideally, dosing apparatus 200 delivers an amount of first fluid 210 to chamber 110 corresponding to an amount of second fluid 215 received in reservoir 205. To this end, dosing apparatus 200 may include an outlet valve 230 that receives first fluid 210 from reservoir 205 via a first conduit 235, and delivers same to chamber 110 via a second conduit 240 having an outlet 245.

Alternatively, as described in greater detail below, reservoir 205, inlet valve 225 and a outlet valve 230 may be configured, or outlet valve 230 eliminated entirely, so that first fluid 210 and second fluid 215 are normally hydrostatically balanced, with first fluid 210 remaining in reservoir 205 until the balance is overcome, for example, with the addition of more second fluid 215. Preferably, either or both of inlet valve 225 and outlet valve 230 are conventional pop-off type valves that are biased into a closed position, but release, preferably only in one direction, when subjected to nominal pressure, e.g. 2 psi.

While the invention is described with an air compressor 120, other fluid dispensers, such as compressed gas or fluid cylinders (not shown), are within the scope of the invention.

A controller 300, preferably including a programmable microprocessor, may be operably connected to inlet valve 225 and outlet valve 230 for controlling either or both in response to sensed conditions in wastewater treatment system 100.

A sensor 400 may be disposed and configured to sense conditions or parameters, for example, in chamber 110. Sensor 400 may respond to or exhibit characteristics corresponding to the parameter, such as population of, or likelihood or suitability of conditions for microbes, bacteria, coliforms, and other tracer organisms used for the identification of the presence of human wastes. Sensor 400 may communicate the response or exhibit a characteristic (hereinafter “generate an input”) corresponding to the sensed parameter to which controller 300 is responsive. Controller 300 may compare the input against comparison data provided in a memory of controller 300 and determine an appropriate response.

The comparison data may correspond to ranges of values for the input that correspond to conditions in chamber 110 that may or may not suggest a need for disinfection. If controller 300 compares the input value against the comparison data and determines that disinfection is needed, controller 300 triggers a dosing event. A dosing event ultimately introduces some of first fluid 210 into chamber 110.

Alternatively or in conjunction with the above, controller 300 may be operably connected to a flow meter 700 that measures the effluent outflow from chamber 110. The relationship between the inflow and outflow over specified periods may factor into triggering dosing events in advance of anticipated high-use periods, or suppressing dosing events in advance of anticipated low-use periods.

A first way to introduce some of first fluid 210 into chamber 110 is to add second fluid 215 to reservoir 205 and urge or displace first fluid 210 out of reservoir 205. This may be accomplished by diverting air ordinarily supplied to diffusers 125 into reservoir 205. As shown, if first fluid 210 is in liquid form, then second fluid 215 should assume a gaseous form, or least be a lighter gas than first fluid 210.

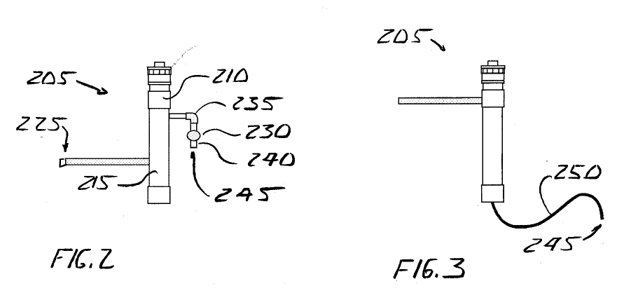

Referring to FIG. 2, if first fluid 210 is in gaseous form, then second fluid 215 should assume a liquid form, or at least be a heavier gas than first fluid 210. In this embodiment, reservoir 205 and the vertical orientation of inlet valve 225 and first conduit 230 are inverted to ensure that first fluid 210 is introduced into chamber 110 and not physically buffered from release by second fluid 215.

Referring again to FIG. 1, diverting air from compressor 120 may be accomplished by opening inlet valve 225, which would allow flow from compressor 120. If, as shown in FIG. 1, apparatus 200 includes outlet valve 230, then it also would need to be opened, or pop off pressure overcome, to allow first fluid 210 to flow out of outlet 245 and into chamber 110.

Referring to FIG. 3, alternatively, apparatus 200 may substitute for first conduit 230, outlet valve 235 and second conduit 240 an outlet line 250 having a configuration or including other mechanisms that do not require positive actuation to allow first fluid 210 to flow into chamber 110. To this end, outlet line 245 may exhibit a “goose neck” configuration and employ gravity to aid in preventing fluid from escaping from reservoir 205 when not desired.

Referring again to FIG. 1, a second way to introduce some of first fluid 210 into chamber 110 is to maintain reservoir 205 at a higher pressure than in chamber 110 and open outlet valve 230 as needed, thereby allowing first fluid 210 to escape under pressure. To this end, inlet valve 225 may be eliminated so that reservoir 205 is in constant fluid communication with compressor 120.

Preferably, first fluid 210 and second fluid 215 are non-miscible or at least resist mixing. An alternative embodiment includes miscible fluids. Another alternative embodiment includes a buffer or impermeable layer 255 disposed between first fluid 210 and second fluid 215. Buffer 255 may be a membrane, a chemical layer, a plate that sliding seals against inner walls of reservoir 205, or combinations thereof.

For disinfection, first fluid 210 may be selected from liquid chlorine, bromine, other appropriate disinfectants or combinations thereof.

Reservoir 205 is selectably gas and/or liquid impermeable, that is, reservoir 205 may be opened to replenish the supply of first fluid 210, and then, once replenished, resealed to define a closed volume.

Preferably, reservoir 205 includes a bleeder valve 260 that dissipates pressure of second fluid 215 in reservoir 205 over a short duration, for example, ten seconds. Bleeder valve 260 allows the pressure in reservoir 205 to reach equilibrium with the atmosphere. Alternatively, bleeder valve 260 may be disposed relative to reservoir 205 and wastewater treatment system 100 so that pressure in reservoir 205 equilibrates with the pressure in wastewater treatment system 100.

Another embodiment of the invention, which may or may not be used with the foregoing embodiments, provides for neutralizing excess disinfectant in the effluent in wastewater treatment system 100. This protects the environment from chemicals used to kill effluent-borne pathogens and other harmful microbes that, if released into the environment, would needlessly harm indigenous organisms and upset the local ecosystem.

One embodiment of an apparatus for neutralizing excess disinfectant configured according to principles of the invention includes one or more diffusers (not shown) disposed in chamber 110. The diffusers (not shown) may be placed in fluid communication with compressor 120 via a third valve (not shown), and thereby introduce air, oxygen or some other agent that neutralizes disinfectant into the treated effluent. Other disinfectant neutralizers and requisite suppliers, reservoirs and dispensers are within the scope of the invention.

Preferably, controller 300 is operably connected to the third valve (not shown) for controlling same in response to sensed conditions in wastewater treatment system 100. A sensor may be disposed, for example, in chamber 110 and configured to sense conditions or parameters in chamber 110, and, like sensor 400, generate a corresponding second input to which controller 300 may respond. Controller 300 may compare this second input against a second set of comparison data provided in the memory of controller 300.

The second set of comparison data may correspond to ranges of values for the second input that correspond to conditions in chamber 110 that may or may not suggest a need for neutralizing disinfectant therein. If controller 300 compares the second input against the second set of comparison data and determines that disinfection neutralization is needed, controller 300 triggers a neutralizing event. A neutralizing event ultimately introduces a neutralizing agent, such as air, into chamber 110.

Preferably, the invention includes tracking the amount of first fluid 210 in reservoir 205, and triggering appropriate functions when the amount of first fluid 210 reaches certain levels. To this end, a level detector 500 may be disposed in, on or in fluid communication with reservoir 205. Similar to sensor 400, level detector 500 responds to the level of first fluid 210 in reservoir 205 and generates a corresponding third input to which controller 300 may respond.

Level detector 500 may include a standard float that floats on top of first fluid 210. Float (not shown) may include a magnet or other mechanism that interacts with one or more switches (not shown) or a position detector (not shown) fixed relative to reservoir 205 when proximate thereto. Interaction of the float (not shown) with a switch or position detector may generate the third input.

Alternatively, level detector 500 may include a pressure transducer (not shown) configured or positioned to detect and generate the third input, which corresponds to pressure in inlet line 235 and/or reservoir 205. A sudden pressure decrease in inlet line 235 and/or reservoir 205 is symptomatic of reservoir 205 being opened, such as if the refiller cap (not shown) is off, or that liquid in reservoir 205 has run out. Accordingly, sharp differences between successive third inputs may suggest a sudden pressure drop.

Preferably, controller 300 is operably connected to the level detector 500, an alarm (not shown) and/or a valve (not shown) that controls discharge from wastewater treatment system 100. In response to the third input or rates of change thereof, controller 300 may compare the third input or rates of change against a third set of comparison data provided in the memory of controller 300.

The third set of comparison data may correspond to ranges of values for the third input or rates of change that correspond to low, depleted and/or other levels or amounts of first fluid 210 in reservoir 205. If controller 300 compares the third input or rates of change thereof against the third set of comparison data and determines that the amount of first fluid 210 in reservoir 205 is low, controller 300 may trigger an alarm (not shown). If controller 300 compares the third input against the third set of comparison data and determines that the amount of first fluid 210 in reservoir 205 is depleted, controller 300 may, in addition to triggering an alarm (not shown), initiate necessary operations to prevent discharge from and/or shut down wastewater treatment system 100.

An alarm (not shown) should adequately warn a wastewater treatment system operator or maintenance personnel that the wastewater treatment system requires attention. To this end, the alarm (not shown) may assume any form, such as a visual or audible signal. The alarm (not shown) may include telephonic communication. Accordingly, controller 300 may be equipped with an appropriate modem (not shown) for telephonic voice and facsimile, or global computer network-based communication. For example, responsive to a “low” or “depleted” determination, controller 300 may initiate a telephone call to the wastewater treatment system operator or maintenance personnel and deliver a voice message that the wastewater treatment system requires more disinfectant or other attention. Alternatively, the controller may send a facsimile message or log onto a global computer network and issue an appropriate e-mail message to the same effect.

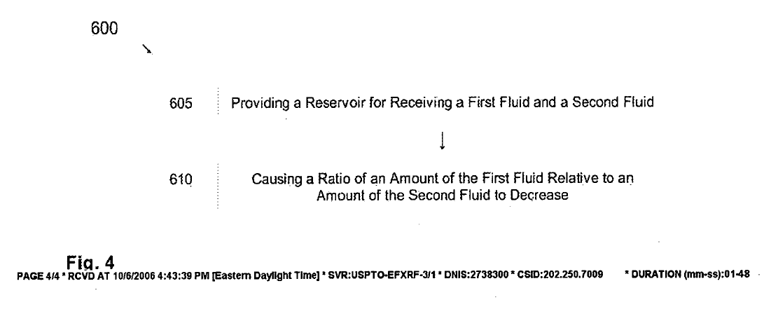

Referring to FIG. 4, an embodiment of a method of dosing a wastewater treatment system 600 configured according to principles of the invention includes: a step 605 of providing a reservoir for receiving a first fluid and a second fluid; and a step 610 of causing a ratio of an amount of the first fluid relative to an amount of the second fluid to decrease. Consequently, the wastewater treatment system receives a second amount of the first fluid.

Step 605 of providing a reservoir for receiving a first fluid and a second fluid may include adding to a wastewater treatment system a reservoir 205 as described above. Most conventional residential and commercial wastewater treatment systems employ an air compressor 120 for delivering air to a portion of the wastewater treatment system dedicated to aerobic effluent break down. An air supply line or inlet line 235 may be connected between air compressor 120 and reservoir 205 using existing valved outlets (not shown) from compressor 120, or by adding a diverter to the supply lines leading from compressor 120 to other components of the wastewater treatment system that compressor 120 supplies.

Step 610 of causing a ratio of an amount of the first fluid relative to an amount of the second fluid to decrease may include controlling inlet valve 225 and/or outlet valve 230, preferably with a controller 300, as described above.

Controller 300 may rely on sensors 400 and 515 to determine how much first fluid 210 and/or second fluid 215 may be needed to achieve desired conditions in the wastewater treatment system. The same or other sensors may provide feedback to controller 300 for calibrating and ensuring accuracy of dosing events.

The invention is not limited to the particular embodiments described and depicted herein, rather only to the following claims.

1. Apparatus for dosing a wastewater treatment system comprising a reservoir configured to receive a first fluid, and having an inlet configured to receive a second fluid and an outlet, wherein second fluid received in said reservoir drives first fluid out of said outlet and into the wastewater treatment system.

2. Apparatus of claim 1, further comprising an outlet valve for controlling flow through said outlet.

3. Apparatus of claim 2, further comprising a controller operably connected to said outlet valve, wherein, responsive to an input, said controller opens said outlet valve.

4. Apparatus of claim 3, further comprising an inlet valve for controlling flow through said inlet, wherein said controller is operably connected to said inlet valve, wherein, responsive to a second input, said controller opens said inlet valve.

5. Apparatus of claim 1, further comprising a bleeder valve for equalizing a pressure of the second fluid in said reservoir with a pressure in the wastewater treatment system or the atmosphere.

6. Apparatus of claim 1, further comprising an inlet valve for controlling flow through said inlet.

7. Apparatus of claim 6, further comprising a controller operably connected to said inlet valve, wherein, responsive to an input, said controller opens said inlet valve.

8. Apparatus of claim 1, wherein the first fluid is a liquid or a gas.

9. Apparatus of claim 1, wherein the second fluid is a liquid or a gas.

10. Apparatus of claim 1, further comprising:
a level detector that detects and generates an input corresponding to a level of the first fluid in said reservoir; and
a controller that is responsive to said input;
wherein, when said controller determines that the input corresponds to a predetermined level, said controller generates an alarm and/or prevents discharge from the wastewater treatment system.

11. Apparatus for disinfecting a wastewater treatment system according to claim 1, wherein the first fluid is a disinfectant.

12. (canceled)

13. (canceled)

14. (canceled)

15. (canceled)

16. Method of dosing a wastewater treatment system comprising:
providing a reservoir for receiving a first fluid and a second fluid; and
causing a ratio of an amount of the first fluid relative to an amount of the second fluid to decrease;
wherein the wastewater treatment system receives a second amount of the first fluid.

17. Method of claim 16, wherein said causing comprises adding second fluid to the reservoir.

18. Method of claim 17, wherein said adding comprises diverting compressed fluid from a fluid source.

19. Method of claim 17, further comprising equalizing a pressure of the second fluid in the reservoir with a pressure in the wastewater treatment system or an ambient atmosphere.

20. Method of claim 16, wherein said causing comprises voiding first fluid from the reservoir.

21. Method of claim 20, wherein said voiding comprises opening a valve that controls flow between the reservoir and the wastewater treatment system.

22. Method of claim 16, further comprising:
ascertaining a level of the first fluid in the reservoir; and, if the level corresponds to a predetermined level,
issuing an alarm and/or preventing discharge from the wastewater treatment system.

23. Method of disinfecting a wastewater treatment system according to claim 16, wherein the first fluid is a disinfectant.

24. (canceled)
